(19) United States
(12) Patent Application Publication
(10) Pub. No.: US 2010/0294469 A1
(43) Pub. Date: Nov. 25, 2010

(54) HEAT DISSIPATING DEVICE FOR MEMORY CARD

(75) Inventor: MING-DER CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/606,198

(22) Filed: Oct. 27, 2009

(30) Foreign Application Priority Data
May 25, 2009 (CN) 200910302593.6

(51) Int. Cl. G06F 1/20; F28F 7/00

(52) U.S. Cl. 165/121; 165/185

(57) ABSTRACT

A heat dissipating device is provided for a memory card which facing airflow blown rearward. The heat dissipating device includes a first heat spreader to be mounted to a front end of the memory card, and a second heat spreader to be mounted to a rear end of the memory card. The heat dissipating device will enhance the heat dissipating efficiency around the memory card.

### BACKGROUND

1. Technical Field

The present disclosure relates to a heat dissipating device for a memory card.

2. Description of Related Art

An electronic device, such as a computer, generally has a plurality of memory cards arranged in parallel on a motherboard in the electronic device. However, a space between every two adjacent memory cards is narrow, which results in low heat dissipating efficiency.

### BRIEF DESCRIPTION OF THE DRAWING

FIG. 1 is a front plan view of an embodiment of a heat dissipating device assembled to a memory card.

FIG. 2 is a side view of FIG. 1.

### DETAILED DESCRIPTION

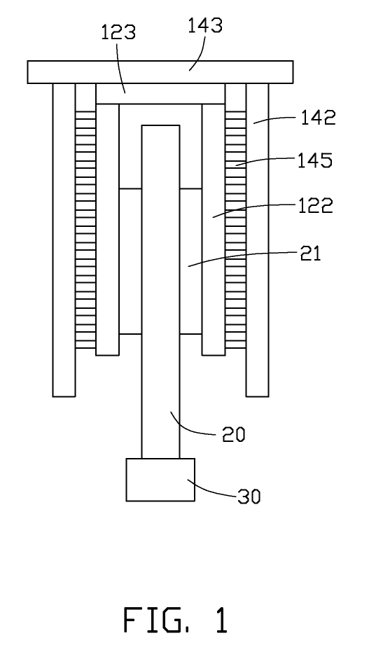

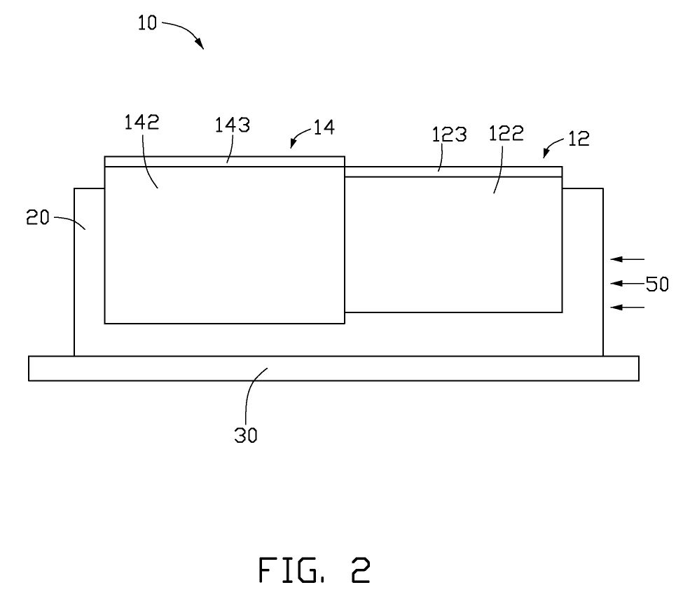

Referring to FIGS. 1 and 2, an embodiment of a heat dissipating device 10 is provided for dissipating heat for a memory card 20. The memory card 20 is installed on a socket 30. A plurality of memory chips 21 are arranged on opposite sides of the memory card 20.

The heat dissipating device 10 includes a first heat spreader 12 and a second heat spreader 14. The first heat spreader 12 is mounted to a front end of the memory card 20, and includes two first heat dissipating portions 122 and a connecting portion 123 connecting tops of the first heat dissipating portions 122. Inside surfaces of the first heat dissipating portions 122 are correspondingly attached to the opposite sides of the front end of the memory card 20, to contact the corresponding memory chips 21 on the front end of the memory card 20. The second heat spreader 14 is mounted to a rear end of the memory card 20, and includes two second heat dissipating portions 142 and a connecting portion 143 connecting tops of the second heat dissipating portions 142. A plurality of fins 145 extend horizontally from inside surfaces of the second heat dissipating portions 142, and are correspondingly attached to the opposite sides of the rear end of the memory card 20, to contact the corresponding memory chips 21 on the rear end of the memory card 20.

In use, airflow 50 is directed rearward to pass across the memory card 20. The first heat dissipating portions 122 of the first heat spreader 12 cool the memory chips 21 on the front end of the memory card 20, and transfer heat of the memory chips 21 from the front end of the memory card 20 rearward. The second heat dissipating portions 142 and the fins 145 of the second heat spreader 14 cool the memory chips 21 on the rear end of the memory card 20, and dissipate heat away from the rear end of memory card 20. Therefore, the heat dissipating efficiency for the memory card 20 is enhanced.

In another embodiment, a length of the first heat spreader 12 is increased to allow the first heat dissipating portions 122 of the first heat spreader 12 to be attached to all of the memory chips 21 on the front and rear ends of the memory card 20. The second heat spreader 14 bestrides a rear end of the first heat spreader 12, to allow the second heat dissipating portions 142 and the fins 145 to be correspondingly attached to rear ends of the first heat dissipating portions 122 of the first heat spreader 12. In use, airflow 50 is directed rearward to pass across the memory card 20. The first heat dissipating portions 122 of the first heat spreader 12 cool the memory chips 21 on the memory card 20 and transfer heat of the memory chips 21 rearward. The second heat dissipating portions 142 and the fins 145 of the second heat spreader 14 cool the rear end of the first heat spreader 12 to enhance the heat dissipating efficiency around the memory card 20.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A heat dissipating device for a memory card which facing airflow directed rearward, the heat dissipating device comprising:
a first heat spreader to be mounted to a front end of the memory card; and
a second heat spreader to be mounted to a rear end of the memory card.

2. The heat dissipating device of claim 1, wherein the first heat spreader comprises two first heat dissipating portions correspondingly attached to opposite sides of the front end of the memory card.

3. The heat dissipating device of claim 2, wherein the second heat spreader comprises two second heat dissipating portions, a plurality of fins extend from inside surfaces of the second heat dissipating portions and are correspondingly attached to opposite sides of the rear end of the memory card.

4. The heat dissipating device of claim 3, wherein the plurality of the fins extend horizontally.

5. The heat dissipating device of claim 3, wherein the first heat spreader further comprises a first connecting portion connecting tops of the first heat dissipating portions, and the second heat spreader further comprises a second connecting portion connecting tops of the second heat dissipating portions.

6. A heat dissipating device for a memory card which facing airflow directed in a rearward direction parallel to the memory card, the heat dissipating device comprising:
a first heat spreader to be mounted to the memory card, the first heat spreader comprising a front end and a rear end along the airflow direction; and
a second heat spreader to be mounted to the rear end of the first heat spreader.

7. The heat dissipating device of claim 6, wherein the first heat spreader comprises two first heat dissipating portions correspondingly attached to opposite sides of the memory card.

8. The heat dissipating device of claim 6, wherein the second heat spreader comprises two second heat dissipating portions, a plurality of fins extend from inside surfaces of the second heat dissipating portions and are correspondingly attached to opposite sides of the rear end of the first heat spreader.

9. The heat dissipating device of claim 8, wherein the plurality of the fins is parallel with the airflow direction.
